(19) United States
(12) Patent Application Publication
(10) Pub. No.: US 2009/0261546 A1
(43) Pub. Date: Oct. 22, 2009

(54) STACKABLE TRAILERS FOR TRANSPORTING CONTAINERS

(76) Inventor: LEROY J. ROWLAND, Folly Beach, SC (US)

Correspondence Address: DORITY & MANNING, P.A., POST OFFICE BOX 1449, GREENVILLE, SC, 29602-1449, US

(21) Appl. No.: 12/104,045

(22) Filed: Apr. 16, 2008

(51) Int. Cl. B62D 39/00

(52) U.S. Cl. 280/33.997; 280/33.998

(57) ABSTRACT

Stackable trailers for transporting both forty and twenty foot trailers and when not in use can be stacked at ports or on ships.

### FIELD OF THE INVENTION

The present subject matter relates generally to trailers that can be pulled by tractors, and more particularly to trailers that can transport twenty foot and forty foot containers and be stacked when not in use.

### BACKGROUND OF THE INVENTION

In recent years a substantial amount of cargo is transported by ships in containers. Some large ships cans carry thousands of containers.

After these containers are unloaded at a port, they are transported on trailers pulled by a tractor. A large number of there containers are twenty and forty feet long normally requiring trailers of different lengths.

It has become a problem as shipping increases to store the trailers prior to the ships being unloaded. Space at the ports for storing the trailers is limited since most of ports are located in large cities close to the sea.

Moreover forty foot trailers are not always suitable for transporting twenty foot containers since the load on the trailers would not be balance lengthwise on the trailer. An unbalanced trailer could overload one of the sets of wheels on the tractor trailer. When a trailer is not balanced properly, such increases the damage on the highways that they travel.

The containers that the trailers are provided to transport are normally used to transport freight over land by rail or by ships. The containers are adapted to be mounted on railroad double-stack or flat cars, highway truck trailer chassis's and stored in stacks on ships.

Freight containers which are capable of being stacked in a superimposed relation are known in the prior art. Examples of such containers are disclosed by U.S. Pat. No. 3,044,656.

Each corner of the container is provided with a corner post connected between associated pairs of upper and lower steel castings which comprise load bearing members of the containers. Conventional openings in each of the steel castings facilitate the interlocking of the containers with suitable lifting means for transferring the container from a land vehicle to a ship and vice versa, as well as to facilitate the positioning and securing together of containers in a stack relationship. U.S. Pat. No. 3,044,653 discloses in detail the method of coupling the containers together when they are being stacked and such is incorporated herein by reference.

### SUMMARY OF THE INVENTION

Objects and advantages of the invention will be set forth in part in the following description, or may be obvious from the description, or may be learned from practice of the invention.

In accordance with aspects of the invention, a stackable trailer is provided for use with a tractor for transporting containers of different sizes and for being stacked to conserve space at ports. The stackable trailer includes an elongated body having a supporting surface thereon. A set of wheels are provided for supporting the rear of the elongated body. A pair of wheel receivers are carried by said elongated body positioned above the set of wheels and below the supporting surface of the elongated body so that when a trailer is stacked thereon the wheels of the upper trailer are supported within the wheel receivers. A retractable landing gear is carried adjacent the front end of the elongated body and engages the ground when it is in an extended position for supporting the front portion of the trailer. A goose neck is provided adjacent the front end of the elongated body of the trailer and includes an inclined surface terminating in a forwardly extending nose.

The retractable landing gear includes a pair of telescoping laterally spaced vertically extending legs. A positioning bar extends between the lower ends of the laterally spaced legs and has an upper surface attached to the lower end of the legs and a flat lower surface for resting on the ground when the trailer is not in use. The trailer is adapted to be stacked with another trailer of the same construction so that when one trailer is stacked on another, the wheels of the upper most trailer is supported by the wheel receivers of the lower trailer and the positioning bar of the upper trailer extends across and is supported on the elongated body of the lower stackable trailer.

An incline member is carried by the positioning bar for mating with the incline surface of the goose neck of another stackable trailer when the trailer is stacked on a lower stackable trailer. Guide members can be positioned on the positioning bar for aiding in positioning one trailer upon another when they are being stacked. The guide member in one particular embodiment includes a pair of space bars that fit between the laterally spaced beams forming the elongated body.

The trailer includes conventional locking mechanisms carried adjacent the front and rear ends thereof for securing large shipping containers on the trailer.

The trailer is equipped with two pairs longitudinally spaced outwardly extending support arms which are carried between the first and second sets of longitudinally spaced locking mechanism for receiving third and fourth sets of locking mechanisms for securing smaller shipping containers onto the trailer. Such permits smaller 20 foot containers to be more less centrally located on the trailer in order to provide a balanced load on the trailer when being transported on the highways.

A conventional overhead crane can be used for stacking the trailers one upon the other when not in use. An overhead crane moves over the trailer and engages connectors carried by the trailer. Once the connectors are locked to the trailer and the overhead crane, the crane lifts the trailers and stacks them one upon the other. When the trailers are stacked the incline member carried by the positioning bar mates with an incline surface of the goose neck of the trailer positioned there below and the wheels of the upper trailer rest within the cradles or wheel receivers of the lower trailer. Accordingly, a crane can stack several trailers one upon the other to conserve space within a port. The trailers can also be stacked on a ship for being moved from one port to another or for transporting the containers being unloaded from the ship.

Particular embodiments of the trailers and stackable features of the trailers are described in greater detail below by reference to the examples in the drawings.

### BRIEF DESCRIPTION OF THE DRAWINGS

FIG. 1 is a perspective view of an embodiment of a stackable trailer according to the invention showing trailers being stacked one upon the other.

FIG. 2 is a perspective view illustrating the positioning bar of the trailer.

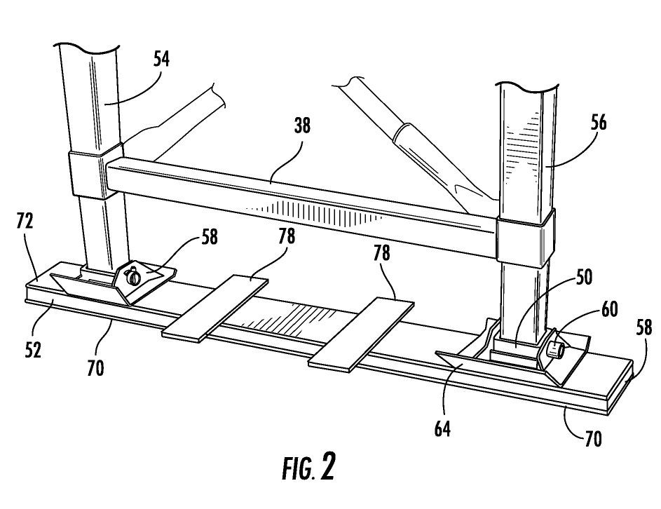

FIG. 3 is a side-elevational view illustrating stacked trailers.

FIG. 4 is partial side-elevational view illustrating the position of the landing gear of a trailer when one trailer is stacked on top of another trailer.

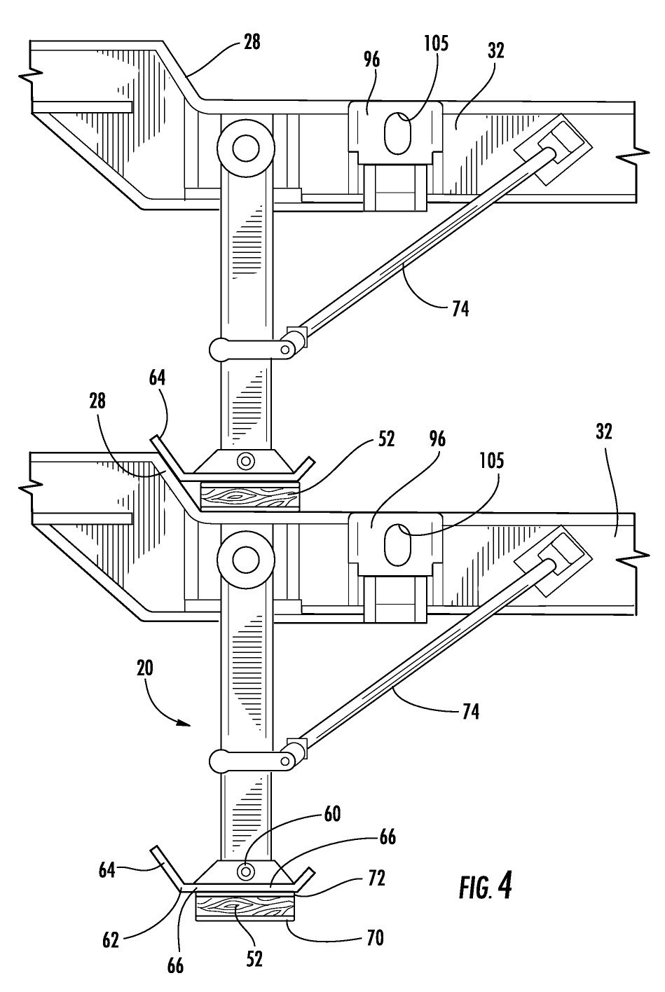

FIG. 5 is a partial plan view illustrating the positioning bar on top of another trailer.

FIG. 6 is a perspective view illustrating the positions of a 40 foot and 20 foot container on a trailer.

FIG. 7 is a fragmentary perspective view illustrating the supporting arm for container connector receiver and a container connector prior to being inserting into the container connector receiver.

FIG. 8 is a partial perspective view illustrating a container connector positioned to be inserted into a corner post of a container.

FIG. 9 is a partial perspective view illustrating a container connector locking a container onto a lateral support arm.

FIG. 10 is a side-elevational view illustrating the position of a 20 foot and 40 foot container when loaded on a trailer.

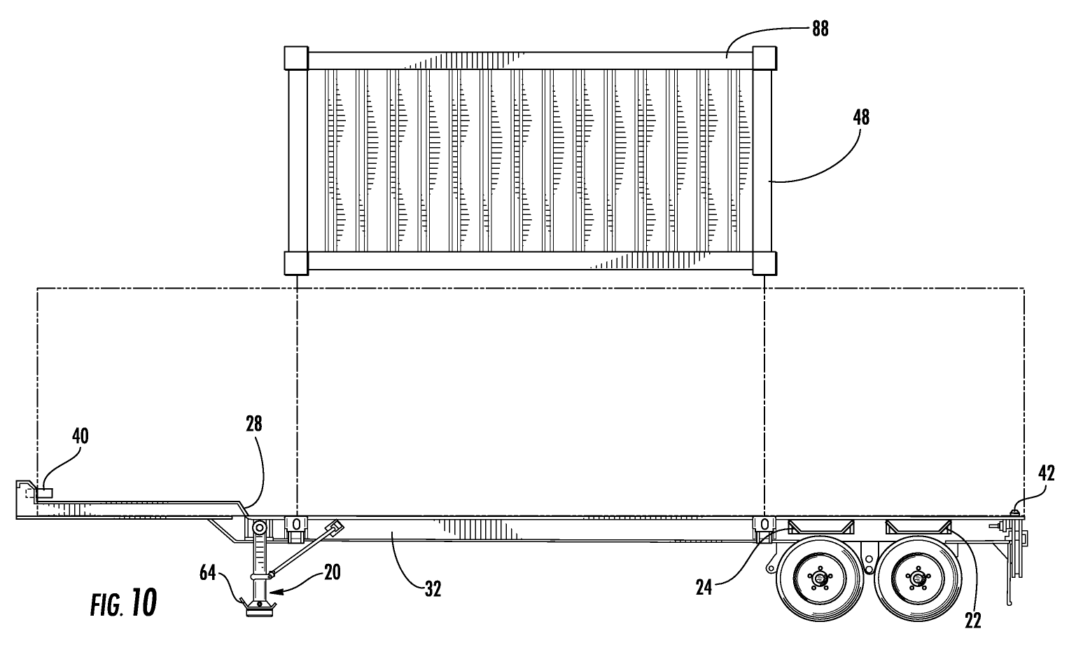

FIG. 11 is a side-elevational view illustrating a crane in schematic form lifting a stackable container.

### DETAILED DESCRIPTION OF THE PREFERRED EMBODIMENTS

Reference will now be made to embodiments of the invention, one or more examples of which are illustrated in the figures. The embodiments are provided by way of explanation of the invention, and are not meant as a limitation of the invention. For example, features illustrated or described as part of one embodiment may be used with another embodiment to yield still a further embodiment. It is intended that the present invention encompass these and other modifications and variations as come within the scope and spirit of the invention.

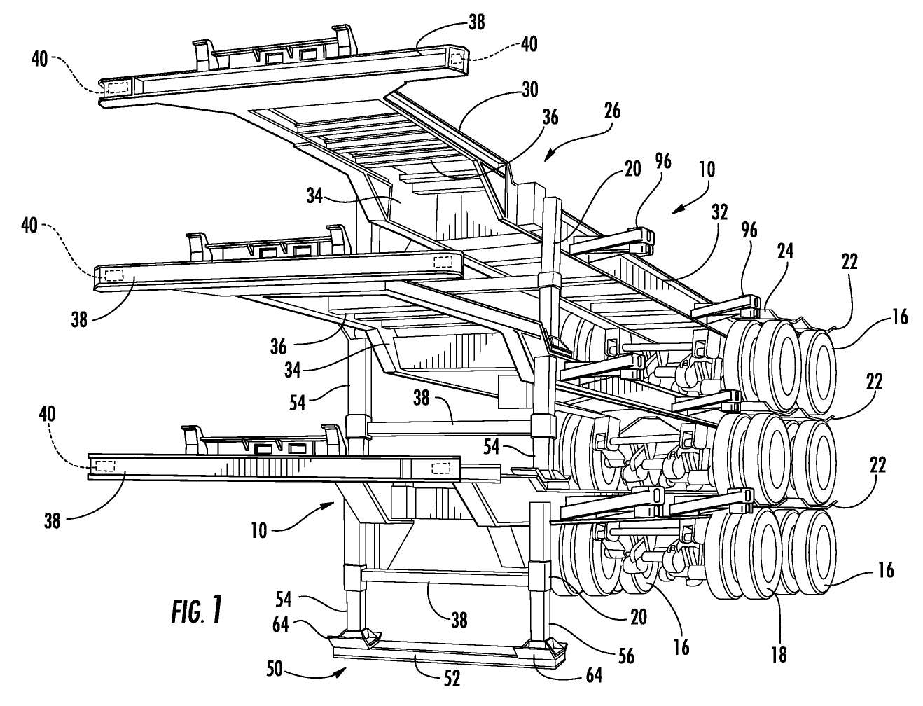

Referring to FIG. 1, three trailers 10 stacked upon each other. Each of the stackable trailers include an elongated body 12 that have a supporting surface 14 provided thereon upon which a container is positioned when being transported. There are two sets of wheels 16 and 18 carried adjacent the rear end of the elongated body 12 for supporting the rear of the trailer. A retractable landing gear 20 extends downwardly adjacent the front end of the trailer 10 for supporting the trailer on the ground and in the stacked position on top of another trailer. There are two pairs 22, 24 of wheel receivers positioned directly over the wheels 16, 18 of the trailer 10 but below the supporting surface 14 of the trailer. These wheel receivers 22, 24 are provided for receiving the wheels 16, 18 of a trailer that is stacked on top when the trailers are in a stacked configuration.

A goose neck 26 is provided adjacent a front end of the elongated body 12 and includes an incline surface 28 which terminates in a forwardly extending nose 30. The trailer 10 is a conventional goose neck trailer that is equipped with wheels and braking systems and a pin for fitting in a fifth wheel of tractor. The pin and tractor connection are not disclosed since it is well-known in the industry.

The trailer 10 is constructed of laterally spaced I-beams 32, 34 which have suitable transverse metal bracing 36 extending therebetween. Positioned adjacent the front end of the trailer is a cross bar 38 that has a conventional locking pin 40 that is used for locking the front end of a container onto the trailer. The mechanism for manipulating the locking pin 40 is not disclosed since it is conventional on goose neck trailers that are constructed for carrying containers. Any suitable connector could be used for locking the front end of a 40 foot container on the trailer.

Normally the trailer has eight wheels carried on the rear end thereof with two sets of four wheels 16, 18 provided on respective spaced axels. As shown in the drawings, there are four wheels on each side of the rear end of the trailer.

Conventional twist locks 42 are carried on the rear end of the trailer and are mounted in a cross bar 44. The twist locks 42 are provided with mechanical or electromechanically operated levers so as to rotated camming surfaces 90 degrees to lock the lower end of the containers onto the trailer. The upper end of the twist lock 42 fits within a hole provided on the corner posts 48 of the containers for locking the containers down onto the trailer. Any suitable conventional locking mechanism could be utilized for locking the containers onto the trailers.

Each of the trailers is provided with a landing gear 20. The landing gear 20 is equipped with a conventional mechanism for raising and lowering the landing gear in a telescoping manner. When the landing gear is lowered, the foot 50 of the landing gear rests on the ground for supporting the front end of the trailer. When the trailers are stacked the foot 50 rests on the next adjacent lower trailer. The foot 50 includes a positioning bar 52 that extends between the vertically extending telescoping posts 54, 56. A connector plate 58 is pivotally connected by a pivot bolt 60 to the bottom of the vertically extending posts 56, 54. Interposed between the connector plate 58 and the positioning bar 52 is an incline plate 62. The incline plate 62 includes a forward angle portion 64 that extends upwardly at an angle of 55 degrees and an intermediate horizontal portion 66 which is attached between the connector plate 58 and the positioning bar 52. The purpose of the incline front portion 64 is to aid in positioning a trailer on top of another trailer when the trailers are being stacked. The incline portion 64 would abut against the 55 degrees incline surface 28 forming part of the goose neck of the lower trailer. The inclined plate 64 could be positioned on the bottom surface of the positioning bar 52 rather than between the connector plate 58 and the positioning bar 52.

The positioning bar 52 in one particular embodiment includes an elongated 2×10 board 68 which is sandwiched between metal plates 70, 72. The metal plate 70 would rest on the asphalt when the trailer is on the ground. In one embodiment, the edges of the bottom plate 70 are beveled to prevent the plate 70 from digging into the asphalt surface when being supported thereon. When the inclined plate 64 is positioned on the bottom surface of the positioning bar 52 as a result of the front and rear sides being inclined upwardly they would not have the tendency to dig into the asphalt surface.

Suitable conventional angle braces 74 extend from the vertically extending telescoping posts 54, 56 and the I-Beams 32 and 34 forming part of the trailer. A cross brace 76 is also positioned between the vertically extending posts 56, 54. Additional bracing could be utilized if found necessary to strengthen the landing gear.

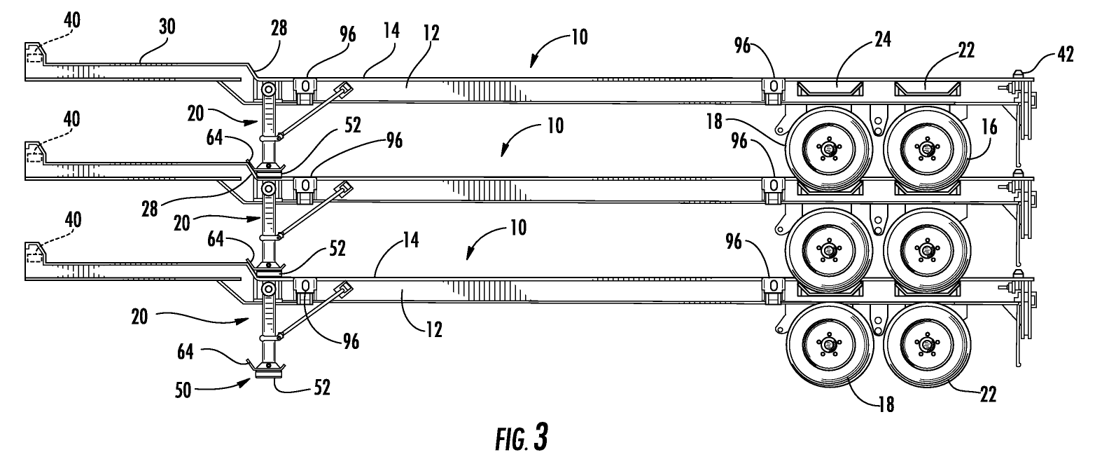

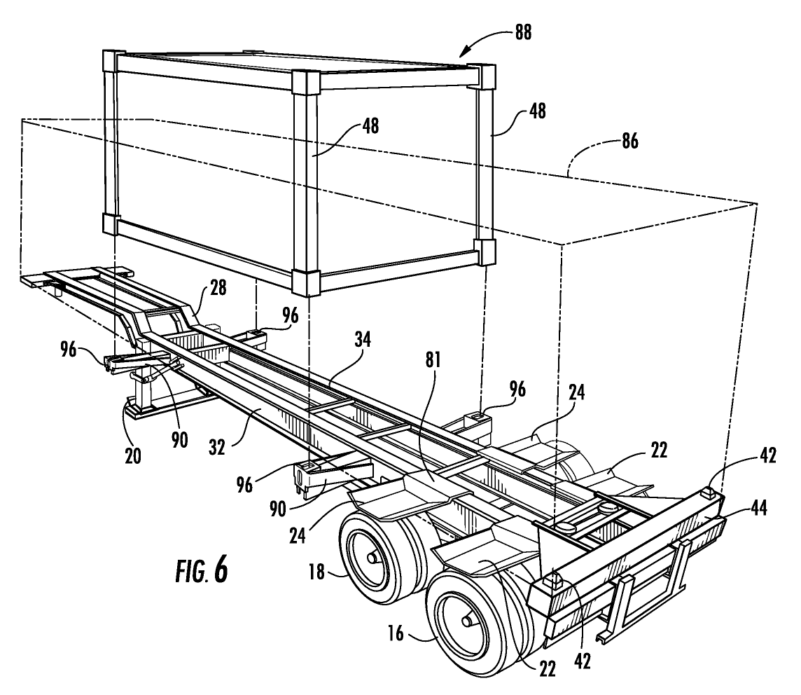

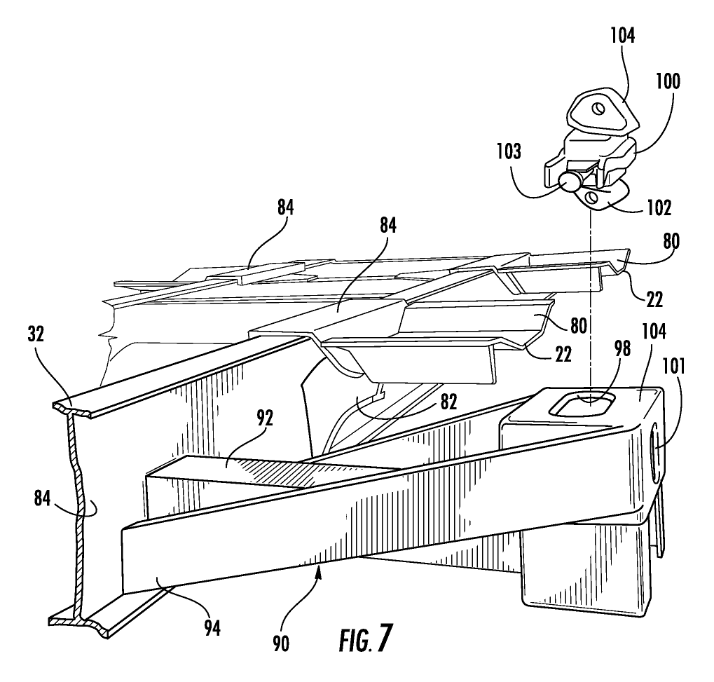

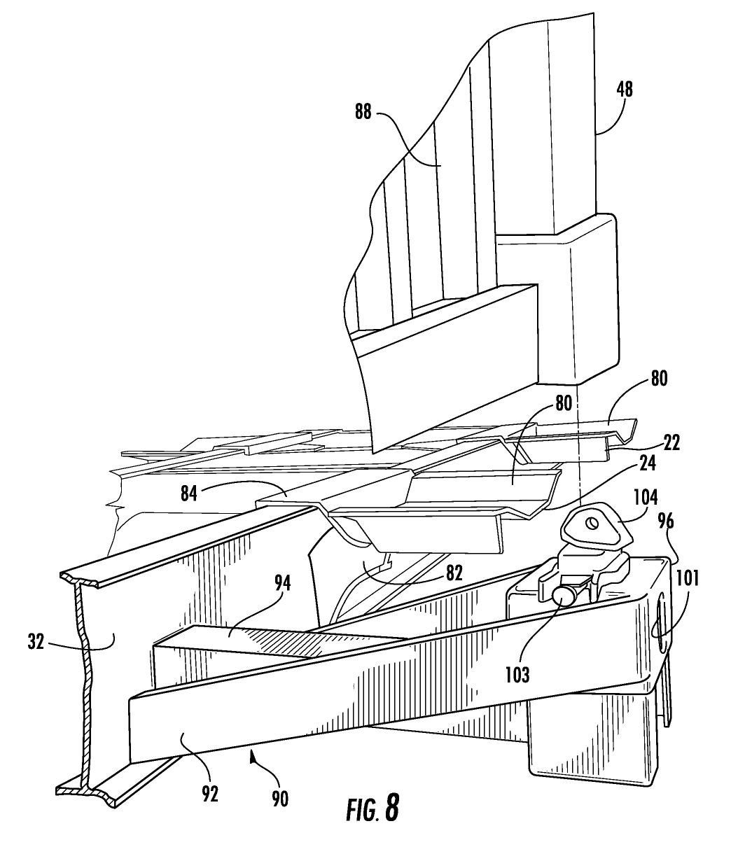

The wheel receivers 24, 26 as shown in FIGS. 3 and 6 through 9 are welded to the I-beams 32, 34 respectively, directly over the wheels 16, 18. The wheel receivers 24 and 26 have a contoured surface 80 corresponding to the curvature of the tire of the trailer so that when a tire is supported in the wheel receiver it can nest therein. The contoured surface 80 is made out of metal and is welded to the I-beams 32, 34 as shown in FIG. 6. Suitable bracing 82 extends from the vertical portion 84 of the I-beam 32 as shown in FIG. 7. This bracing 82 provides a connection between the vertical flange of the I-beam and the lower portion of the wheel receivers 24 and 26 for supporting the wheel receiver on the I-beam. In my earlier, U.S. Pat. No. 5,934,695, the wheel receivers 24 and 26 were removable attached to the I-beams, however, they could also be fixed by welding to the I-beam as shown in FIG. 7. In FIG. 7 and 8, there is a flange 84 that extends up and over top of the I-beam 32 for aiding in supporting the cradle receivers 22, 24. In some embodiments it may be desired to remove the flange 84 and only use bracing between the cradle 80 of the wheel receivers 22, 24 and the vertical extending flange of the I-beam. Such would permit the upper supporting surface of the I-beam 32 to be flat and smooth and enable the upper edge of the wheel receivers to be below the upper supporting flanges of the I-beams 32, 34.

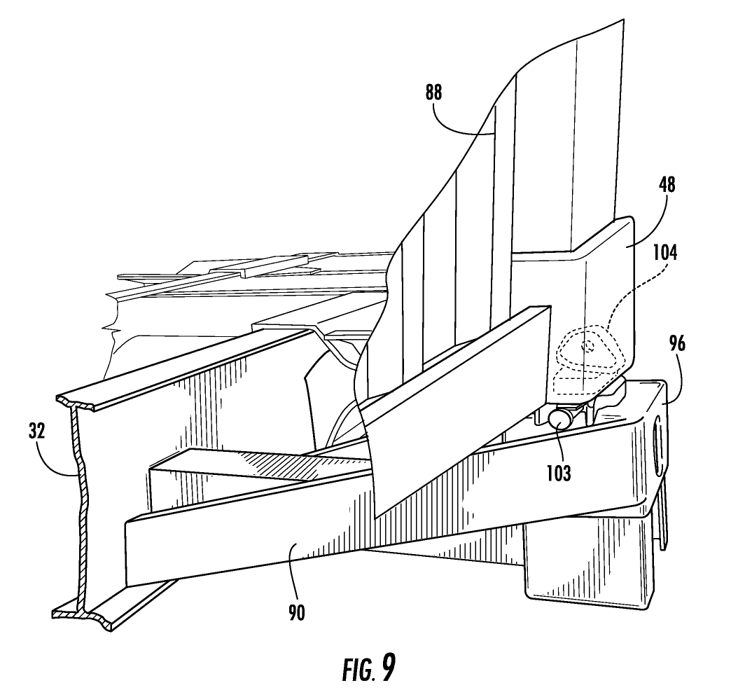

Referring to FIG. 6, there is shown in dotted lines the position of a forty foot container 86 when it is mounted on the trailer for being transported. In order for the trailer to transport a 20 foot container 88 four sets of outwardly extending support arms 90 are supported on the I-beams 32, 34 and extend laterally outwardly therefrom. The outwardly extending support arms 90 are positioned on the I-beams 32, 34 as shown in FIG. 6 so that the weight of a container 80 would be balanced between the front and rear of the trailer in order to minimize overloading of the rear wheels of the trailer or the rear wheels of the tractor pulling the trailer. A container connector receiver 96 is connected by welding or any other suitable means to the outward extending arms 92, 94. This connector receiver 96 is in the form of a hollowed block which has an opening 98 provided in the top thereof so that a container connector such as a twist lock connector 100 can be inserted therein. The twist lock connector 100 has moveable flanges 102, 104 that can be rotated so that the lower flange 102 bears on the underside of the top surface 104 of the container connector receiver. The upper camming surface 104 is inserted through an opening provided in the lower end of a corner post of the container as shown in FIG. 9 for locking the container down onto the supporting arms through the container connector receivers 96.

The twist locks 100 can be removed from the container connector receivers 96 when the trailer is being used for transporting a forty foot container. However, when a longshoreman is loading a twenty foot container 80 onto the trailer he first inserts the twist lock connector 100 into the opening 98 of the container connector receivers 96. Once the container is positioned on the trailer with the upper cramming surface 104 extending into the corner post 80 of the container, the twist lock member is manipulated by a lever or a spring loaded plunger 103 to rotate the camming surfaces 102, 104 90 degrees for locking the container 88 onto the four laterally extending support arms. An access to the plunger 103 or a lever if used is provided through an opening 101 in an end wall of the container connector receiver 96 or an opening 105 in the side wall. The twist lock connectors 100 are conventional twist locks that are in use now for locking the rear end of containers on trailers and also for use when stacking containers one upon the other to lock a bottom of one container to the top of a container positioned therebelow. The twist lock connectors 100 extend into the corner posts of the containers for locking the containers in stacks by rotating the camming surfaces 102, 104 90 degrees.

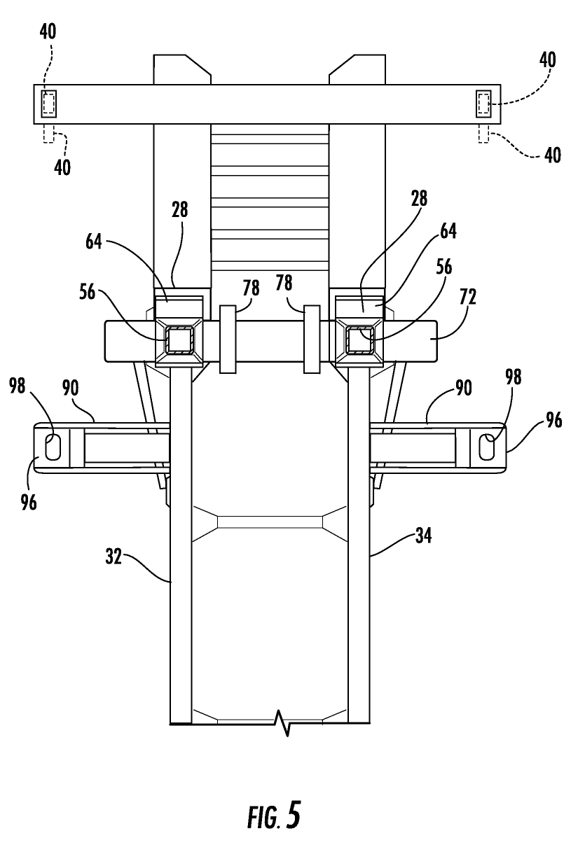

As can be seen in FIGS. 3 and 5 the container connector receivers 96 are laterally supported outwardly from the I-beams 32 and 34 on both sides of the trailer so that there are four container connector receivers 96 used for locking a twenty foot container onto the trailer. A first pair of container connector receivers 96 is positioned near the rear wheels of the trailer with a second pair of container connector receivers being located close to the landing gear. When a twenty foot container is transported on the trailer it presents a balanced load. A balanced load along the length of the trailer provides a smoother ride on the highway and minimizes damages to the highway as compared to when one set of wheels or the other is overloaded.

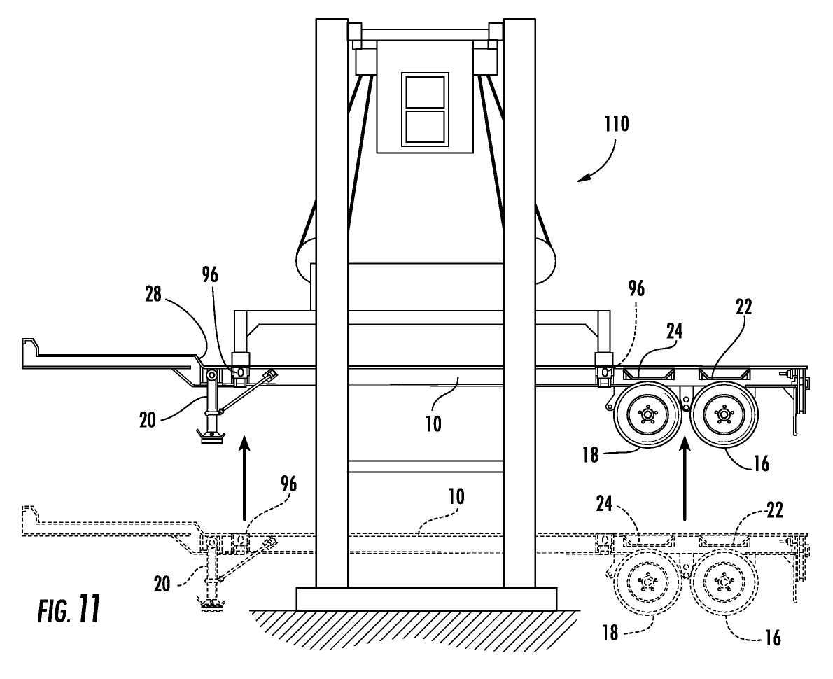

FIG. 11 illustrates an overhead crane 110 lifting the trailers for stacking one upon the other. While the overhead crane 110 shown in FIG. 11 is in a fixed position it is understood that the overhead crane could be mounted on wheels. When the overhead crane is mounted on wheels it enables the crane to move to where the trailers are being stacked or unstacked for moving them to a loading or unloading position. The crane 110 shown in FIG. 11 lifts a trailer off the ground and moves it over another trailer so that it can be lowered on top of the second trailer with the rear wheels of the upper trailer nesting in the wheel receivers 24 and 26 of the lower trailer. The incline plates 62 carried by the positioning bar nests against the incline surface 28 of the goose neck of the lower trailer.

In order to couple the trailer to the crane any suitable connectors 100 could be used between a frame of the crane and the laterally spaced support arms which support the container connector receivers 96. In one particular embodiment, conventional twist locks are used. The twist locks are inserted in the container connector receivers 96 and the crane has mechanisms for engaging such twist locks similar to the way that the present prior art cranes are being used to lift containers off of ships. The trailers can also be stacked on container ships or barges in order to transfer trailers from one port to another.

What is claimed:

1. A first stackable trailer for use with a tractor for transporting containers comprising;
an elongated body,
a supporting surface provided on said elongated body,
a set of wheels supporting a rear end of said elongated body,
a pair of wheel receivers carried by said elongated body positioned above said set of wheels and below said supporting surface of said elongated body.
a retractable landing gear carried adjacent a front end of said elongated body;
a goose neck provided adjacent a front end of said elongated body including an inclined surface terminating in a forwardly extending nose.
said retractable landing gear including a pair of laterally spaced vertically extending legs;
a positioning bar extending between a lower end of said laterally spaced legs having an upper surface attached to said lower end of said legs and a substantially flat lower surface for resting on the ground when the trailer is not in use, and
a second stackable trailer of the same construction as said first stackable trailer so that when said first stackable trailer is stacked on said second stackable trailer the wheels of said first stackable trailer are supported by said wheel receivers of said second stackable trailer and said positioning bar of said first stackable trailer extends across and is supported on said elongated body of said first stackable trailer.

2. The stackable trailer as set forth in claim 1 further comprising:
an inclined member carried by said positioning bar for mating with said inclined surface of said goose neck of said second stackable trailer when said first stackable trailer is stacked on said second stackable trailer.

3. The first and second stackable trailers of claim 1 further comprising:
said elongated body of said trailers including a pair of laterally spaced beams,
a guide member carried by said positioning bar of said first and second stackable trailers extending between said laterally spaced beams when said first stackable trailer is stacked on said second stackable trailer for aiding in stacking said trailers.

4. The stackable trailer as set forth in claim 1 wherein said wheel receivers are cradles having a curvature corresponding to the curvature of the outer surface of said wheels.

5. The stackable trailer as set forth in claim 1 further comprising a first and second set of longitudinally spaced locking mechanisms carried by said elongated body for securing a large shipping container onto said trailer.

6. The stackable trailer as set forth in claim 5 further comprising two pairs of longitudinally spaced outwardly extending support arms carried on said elongated body between said first and second sets of longitudinally spaced locking mechanism,
third and fourth sets of longitudinally spaced locking mechanisms carried by said outwardly extending support arms for securing a smaller shipping container onto said trailer.

7. A trailer for use with a tractor for transporting containers of different lengths comprising:
an elongated body,
a set of rear wheels for supporting a rear end of said elongated body,
a first set of container connectors carried adjacent a rear end of said elongated body,
a second set of container connectors carried adjacent a front end of said elongated body, said first and second sets of container connectors being longitudinally spaced for securing containers of a first size on said elongated body,
a first set of container connector receivers carried towards a rear portion of said elongated body between said first and second sets of said container connectors,
a second set of container connector receivers carried towards a front portion of said elongated body between said first and second sets of said container connectors,
said first and second sets of container connector receivers being longitudinally spaced for securing containers of a second size smaller than said first size containers on said elongated body.

8. The trailer as set forth in claim 7 further comprising;
laterally extending support arms carried by said elongated body for supporting respective ones of said first and second sets of container connector receivers.

9. The trailer as set forth in claim 7 wherein said containers of said first size are 40 foot containers.

10. The trailer as set forth in claim 7 wherein said containers of said second size are 20 foot containers.

11. The trailer as set forth in claim 7 further comprising:
a supporting surface provided on said elongated body,
wheel receivers carried by said elongated body positioned above said set of wheels and below said supporting surface of said elongated body,
a retractable landing gear carried adjacent a front end of said elongated body,
a foot carried by said landing gear,
said trailer adapted to support another trailer of the same construction with said rear wheels of said another trailer resting in said wheel receivers and said foot of said another trailer resting on said supporting surface.

12. The trailer as set forth in claim 11 further comprising:
an overhead crane connector carried in said container connector receivers for providing a connection between said overhead crane and said trailer so that said trailer can be lifted and stacked on top of another trailer.

13. The trailer as set forth in claim 11 wherein said foot is a positioning bar.

14. The trailer as set forth in claim 13 further comprising:
a goose neck provide adjacent a front end of said elongated body including an inclined surface terminating in a forwardly extending nose.

15. The trailer as set forth in claim 14 further comprising:
an inclined member carried by said positioning bar for mating with said inclined surface of said goose neck of another stackable trailer when said trailers are stacked one on another.
